(19) United States
(12) Patent Application Publication
(10) Pub. No.: US 2024/0430077 A1
(43) Pub. Date: Dec. 26, 2024

(54) MANAGING AUTHENTICATION CREDENTIALS IN MULTIPLE DEVICES

(71) Applicant: TruU, Inc., Palo Alto, CA (US)

(72) Inventors: Lucas Allen Budman, Denver, CO (US); Amitabh Agrawal, Superior, CO (US)

(21) Appl. No.: 18/751,010

(22) Filed: Jun. 21, 2024

Related U.S. Application Data
(60) Provisional application No. 63/522,309, filed on Jun. 21, 2023.

(51) Int. Cl. H04L 9/08

(52) U.S. Cl. CPC H04L 9/0825

(57) ABSTRACT

An authentication server receives a request to access an authentication server from a first device. The authentication server receives one or more proximity signals transmitted from the first device and one or more proximity signals transmitted from a second device. The second device has a trust relationship with the authentication server. The authentication server confirms that the first device and the second device are in proximity to each other based on the one or more proximity signals transmitted from the first device and second device. The authentication server verifies the trust relationship with the second device by decrypting a signed message received from the second device after confirmation that the first device and the second device are in proximity to each other. The authentication server updates a trust relationship between the first device and the server based on the verified trust relationship between the second device and the server.

### CROSS REFERENCE TO RELATED APPLICATIONS

This application claims the benefit of U.S. Provisional Application No. 63/522,309, filed on Jun. 21, 2023, which is incorporated by reference in its entirety.

### TECHNICAL FIELD

This disclosure relates generally to techniques for managing trust relationships between computing devices and, more specifically, to techniques for managing authentication credentials in multiple devices.

### BACKGROUND

An authentication device may provide proof of user identity when requesting access to a server system and certain components provided by the server system. Authentication credentials stored within the authentication device and at the server system establish device authenticity, and by extension, may provide proof of user identity. However, provisioning an authentication device with the authentication credentials may involve a potentially costly procedure, sometimes requiring both the user and an authorized credential service provider staff member to be present. Prior art techniques for provisioning a replacement or backup authentication device for an existing, trusted user still require the same costly procedures associated with provisioning a new authentication device for a new user.

### BRIEF DESCRIPTION OF DRAWINGS

FIG. 1 shows a computing environment, according to one embodiment.

FIG. 2 illustrates an example process for creating a new trust relationship between an authentication server and a destination authentication device, according to one embodiment.

FIG. 3 illustrates an example process for executing a trust management operation to create a trust relationship between an authentication server and a destination authentication device, according to one embodiment.

FIG. 4 illustrates an example process for a source authentication device to initiate a new trust relationship between an authentication server and a destination authentication device, according to one embodiment.

FIG. 5 illustrates an example process for a destination authentication device to establish a new trust relationship with an authentication server, according to one embodiment.

FIG. 6 illustrates an example process for an authentication server to establish a new trust relationship with a destination authentication device, according to one embodiment.

FIG. 7 illustrates an example configuration of a computer system, according to one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

Embodiments of the present disclosure facilitate creating a new trust relationship between an authentication device and an authentication server based on an existing trust relationship between another authentication device and the authentication server. As described herein, a trust relationship comprises an information state or condition established between two computing devices, such that one computing device can trust the authenticity of a second computing device. For example, an authentication server (e.g., a computing device comprising one or more computer server systems) may have a trust relationship with an authentication device (e.g., a mobile computing device), thereby trusting the authentication device is authentic during mutual communication sessions. In some embodiments, the trust relationship is established through a public-private key pair. Although various techniques for establishing and testing a trust relationship between an authentication server and an authentication device are described herein, a person of ordinary skill in the art will recognize that these techniques may be applied symmetrically such that the authentication device may also have a trust relationship (or not) with the authentication server.

In one example embodiment, a first authentication device generates a public-private key pair and shares the public key with an authentication server in a controlled operational scenario. The controlled operational scenario independently authenticates the first authentication device, for example through an in-person provisioning session, an email with a one-time use code or link sent to the authorized user, and so forth. The authentication server may use the public key to test and verify the trust relationship with the first authentication device, for example as described herein. Additionally, the first authentication device may cooperate with the authentication server to generate a new trust relationship between a second authentication device and the authentication server. The second authentication device may inherit and retain the same trust level granted to the first authentication device. For example, a mobile device associated with a first user (referred to as “mobile device A”) has a trust relationship with a server that has a private key for mobile phone A and a public key corresponding to the private key. A trust relationship with a new mobile device (referred to as “mobile device B”) involves generating a new private key and sharing the corresponding public key with the server. Any privileges, access permissions, or other attributes associated with device A's trust relationship, as stored or recorded by the server, may be transferred and/or copied in the server's records from device A to device B (i.e., inherited by device B).

A trust level or identity assurance level (IAL) may be assigned to a user and/or authentication device based on the circumstances associated with the creation of the trust relationship. Exemplary IALs are defined in, for example, the National Institute of Standards and Technology (NIST) standard SP 800-63-3. In particular, NIST standard SP 800-63-3 IAL level 3 (or simply “IAL3”) specifies that physical presence is required for identity proofing of a new user, and that identity attributes must be verified by an authorized and trained representative of a credential service provider (CSP). Inheriting and retaining a trust level of IAL3 may provide operational efficiency by avoiding additional in-person meetings once a user identity is proven and associated with the first authentication device.

### System Environment Example

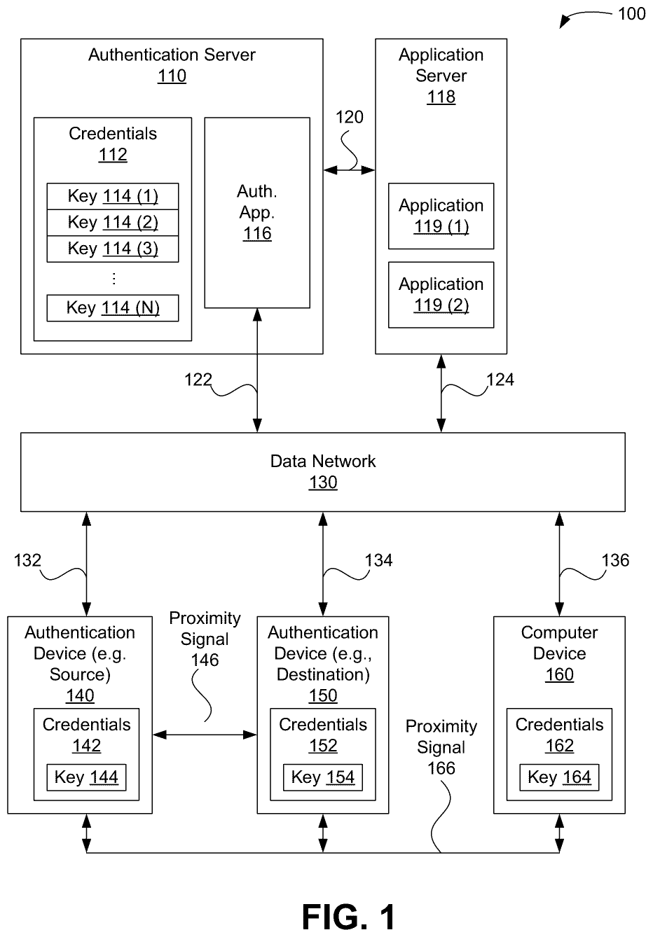

FIG. 1 shows a computing environment 100, according to one embodiment. The computing environment 100 includes an authentication server 110, an application server 118, a data network 130, a first authentication device 140, a second authentication device 150, and a computer device 160. Although FIG. 1 illustrates only a single instance of the components of the computing environment 100, more than one of each component may be present in practice and additional or fewer components may be used.

The data network 130 communicatively couples the authentication server 110, the application server 118, the authentication devices 140, 150 and the computer device 160. The data network 130 provides data communication between the authentication server 110, authentication devices 140, 150, computer device 160, and certain additional devices (not shown). In an embodiment (e.g., when data link 120 is not available), the data network 130 provides data communication between the authentication server 110 and the application server 118. The data network 130 may include any technically feasible collection of switching, routing, and transport systems, as well as any form or forms of physical data links. For example, data links 122 and 124 may each comprise one or more fiber optic channels, while data links 132, 134, and 136 may each comprise a wireless data link (e.g., WiFi, 5G/LTE, 4G, etc.).

As shown in the illustrated embodiment, the authentication server 110 includes an authentication application 116 and credentials 112. The authentication application 116 comprises programming instructions for establishing, testing, and verifying a trust relationship between the authentication server 110 and authentication devices (e.g., authentication devices 140, 150) by performing various methods, procedures, and techniques described herein. The programming instructions may be stored in one or more non-transitory computer readable (machine-readable) storage mediums, such as a solid-state disk (SSD) storage device or array, a conventional hard disk drive or array of such drives, an optical disk, a system memory (e.g., dynamic random access memory or “DRAM,” etc.), or any other suitable storage medium.

The authentication application 116 may determine whether a valid trust relationship exists between the authentication server 110 and a computing device, such as authentication devices 140, 150 and computer device 160. Devices having a valid trust relationship with the authentication server 110 are referred to herein as “trusted devices” (alternatively, “trusted computing devices” or “trusted authentication devices”). In response to the authentication application 116 determining that a valid trust relationship exists with a trusted computing device”, the authentication server 110 may perform additional operations, for example permitting the trusted computing device (e.g., authentication devices 140, 150 and/or potentially computer device 160) to access functions on the application server 118, creating a new trust relationship, or invalidating an existing trust relationship. For example, the computing device may invalidate an existing trust relationship to maintain or comply with a policy limit on the number of trusted devices for a given user/account.

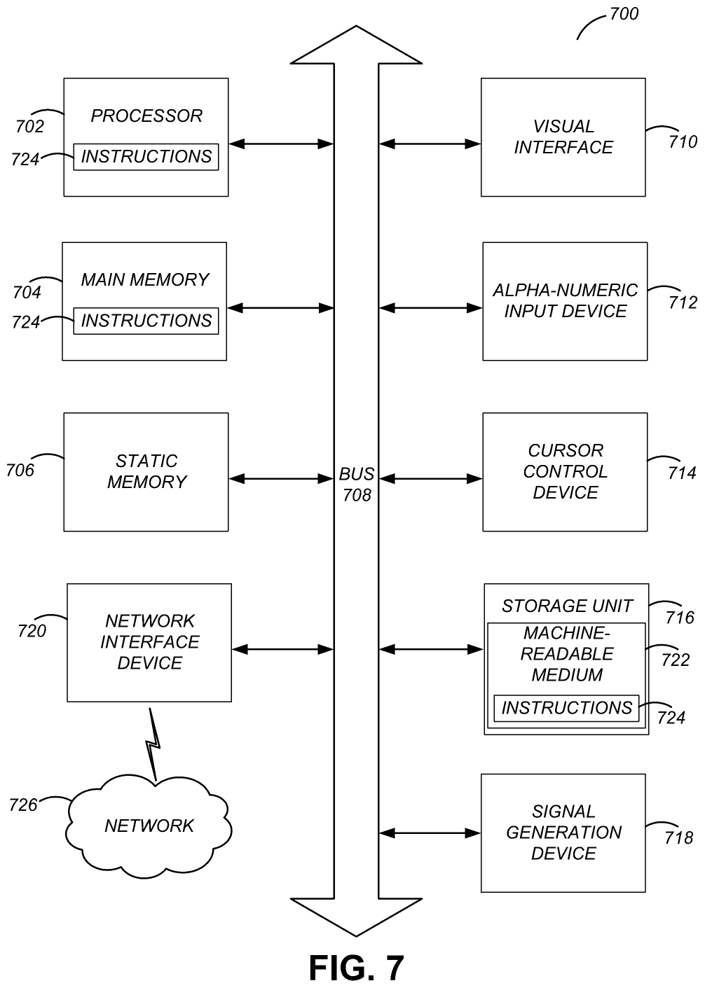

As described herein, a computing device may include any device or system through which a user may interact with the application server 118 via the network 130. An example physical implementation is described more completely below with respect to FIG. 7. A given computing device may be configured to communicate with the authentication server 110 and the application server 118. The communication also may be wireless, for example, via a short-range communication protocol such as Bluetooth. Authentication devices 140 and 150 may be mobile devices (e.g., a cellular phone or smartphone, personal digital assistants, tablet computer or any other handheld device including computing functionality and data communication capabilities to execute one or more of the processing configurations described herein) whereas the computer device 160 may be a desktop computer, laptop computer, or any other computer system including computing functionality and data communication capabilities to execute one or more of the processing configurations described herein. Each computing device and each authentication device may include access credentials including a private key of a public-private key pair. Access credentials 142, 152, 162 and keys 144, 154, and 164 are further described below.

The credentials 112 comprise one or more keys 114(1)-(N) for establishing and maintaining trust relationships with various other devices, for example authentication devices 140, 150, and computer device 160. In an embodiment, the credentials 112 are organized in a credentials database (not shown) that includes the credentials 112 and related data, properties, and permissions of corresponding authentication devices and associated account details (e.g., a user name, associated user information and/or a human resources identifier, etc.). For example, the credentials database may store and associate each key 114 with an authentication device identifier and a set of permissions defining which services provided by the authentication server 110 and/or application server 118 the authentication device may access. In one embodiment, the credentials database may be stored within the authentication application 116. In another embodiment, the credentials database functions and is stored separate from the authentication application 116 and the authentication application 116 accesses data stored within the database while performing operations related to trust relationships.

The authentication server 110 may manage and maintain trust relationships using public-private key pairs to verify device identity and trust. In one embodiment, the authentication server 110 may store the public key of a public-private key pair while the authentication device in the trust relationship stores the corresponding private key of the public-private key pair. The keys 114 stored at the authentication server 110 may be public keys while the corresponding private keys are stored at various authentication devices. For example, key 114(1) is a public key of a public-private key pair and key 144 is the corresponding private key. Key 114(2) is a public key of a public-private key pair and key 154 is the corresponding private key. Key 114(2) is a public key of a public-private key pair and key 164 is the corresponding private key. In response to an instruction from the authentication application 116, the authentication server 110 may test a trust relationship between the application server 118 and an authentication device (e.g., an authentication device 140) by transmitting a message to the authentication device 140. The authentication device 140 signs the message by encrypting it based on the private key 144 and transmits the encrypted message back to the authentication server 110. In some embodiments, the message and the signed message may be separately encrypted for transmission, for example by transmitting the messages through a secure socket layer (SSL) or through a transport layer security (TLS) protocol. If the encrypted message (e.g., the message using the private key 144) is successfully decrypted using the corresponding public key 114(1), the authentication server 110 determines the trust relationship is valid and proceeds with any subsequent operations that depend on a valid trust relationship. The technique for testing a trust relationship described herein is only an example of potential techniques. A person of ordinary skill in the art would appreciate that any technically feasible technique for testing trust may be performed without departing the scope and spirit of various embodiments.

If the authentication server 110 verifies a trust relationship with an authentication device (e.g., as described herein), the authentication server 110 transmits the verification information to the application server 118 via data link 120. As shown, application server 118 comprises one or more applications 119(1)-(N). Each of the applications 119 comprises programming instructions that cause one or more processor circuits within the application server 118 to perform various methods, procedures, and techniques described herein. The programming instructions may be stored in a non-transitory computer readable storage medium, examples of which are given herein. Access to specific applications 119 may be granted on a per computing device basis, so a given application 119 may provide various application services to client computing devices, such as computer device 160. The application server 118 allows a trusted computing device (e.g., computer device 160) to access one or more permitted applications 119 at the application server 118. In certain embodiments, a given computing device having a valid trust relationship with the authentication server 110 may have access to a particular set of applications 119. For example, the computer device 160 may have access to application 119(1), but not application 119(2). In some embodiments, the application server 118 only allows a trusted computing device access to the applications 119. For example, the computer device 160 can only access the applications 119 once the authentication server verifies a trust relationship between the authentication server 110 and the computer device 160 itself.

In other embodiments, the computing device seeking to access the applications 119 is a separate and distinct device from the trusted authentication device. In such embodiments, the authentication server 110 may receive a request from the computing device (e.g., computer device 160) to access applications 119 at the application server 118. The authentication server 110 may verify a trust relationship with the trusted authentication device associated with the user before granting the computing device access to any potential permitted applications 119. Consider an implementation where a user attempts to access applications 119 from the computing device and also carries a mobile device that serves as the trusted authentication device (e.g., authentication device 140). The authentication server 110 may authenticate the identity of the user by verifying a trust relationship between the server 110 and the trusted authentication device. For example, the authentication server 110 may verify the trust relationship with the trusted authentication device 140 (associated with an authorized user) and allow the computing device 160 to access the permitted applications 119 in response to verifying the trusted relationship with the trusted authentication device. In such implementations, the authentication server 110 further verifies that the trusted authentication device is in proximity to the computing device before allowing the computing device to access the permitted applications 119.

The authentication application 116 may measure physical proximity between two authentication computing devices (also referred to as a source authentication device and a destination authentication device) using any technically feasible technique, including transmitting and measuring local proximity signals (e.g., proximity signals 146 and 166), and/or geo-location sensing. As described herein, a proximity signal may include one or more signal components that individually or collectively indicate actual physical proximity between computing devices. A proximity signal may include any optical, electromagnetic, magnetic, acoustic, or mechanical signal(s) or a combination of signals.

An optical proximity signal may include one-dimensional or two-dimensional (2D) information, time-series information, or a combination thereof. For example, an optical proximity signal may comprise a 2D array image (e.g., a 2D “bar code” or quick response “QR code”). In some embodiments, the 2D array image may change over time to form a time-series of 2D data, so a given 2D array image may be valid for a certain time window. The authentication server 110 may measure proximity between two computing devices, for example authentication devices 140 and 150, using an optical proximity signal transmitted from a display screen of one computing device to a digital camera at another computing device. For example, the computing device may display the optical proximity signal and the trusted authentication device may receive the optical signal using a built-in digital camera. The authentication server 110 may optionally transmit a different 2D array image in the opposite direction.

An electromagnetic proximity signal may include a digital data sequence modulated over a radio-frequency (RF) channel (e.g., a channel with a relatively short detection range). For example, an electromagnetic proximity signal may comprise an industry standard Bluetooth channel established between two devices (e.g., authentication device 140 and authentication device 150). Alternatively, an electromagnetic proximity signal may comprise an industry standard WiFi channel established directly between the two devices. Bluetooth and WiFi digital radio circuits are commonly available in most modern smartphone devices and are suitable to facilitate reliable transmission of electromagnetic proximity signals. The authentication server 110 may measure proximity between two computing devices using an electromagnetic signal by transmitting data over the RF channel established between the two computing devices. A person of ordinary skill in the art would appreciate that any other technically feasible electromagnetic communication technique may be employed without departing the scope and spirit of various embodiments.

A magnetic proximity signal may include a digital data sequence modulated over a magnetically-coupled channel, for example an industry standard near field communications (NFC) channel. Support circuits for NFC communication are also commonly available in modern smartphone devices and may be used to facilitate transmission of magnetic proximity signals. The authentication server 110 may measure proximity between two computing devices and/or authentication devices using a magnetic signal by transmitting data over the NFC channel established between the two devices.

An acoustic proximity signal may include an acoustic (e.g., audio) signal transmitted between two authentication devices (e.g., authentication device 140 and authentication device 150). The acoustic signal may be within or beyond typical human hearing range and may include a modulated data signal, an audible musical melody or chime sequence, and so forth. In one embodiment, the authentication server 110 may measure proximity between two computing devices using acoustic proximity signals by transmitting and receiving the acoustic signal between the two computing devices. In another embodiment, the authentication server 110 measures proximity by determining whether both computing devices detect a substantially identical ambient acoustic environment. The authentication server 110 may determine such a detection independent of or in addition to transmission of the acoustic signal between both computing devices.

A mechanical proximity signal may include any physical movement or vibration occurring between two computing devices. For example, bumping or tapping authentication device 140 and authentication device 150 together to create an impact event observable by both devices. The impact event generates at least one of an accelerometer signal and an acoustic signal concurrently in both devices. The authentication server 110 measures proximity by determining whether both computing devices concurrently detected accelerometer signals and determining that the accelerometer signals are highly similar during a transient impact event. A comparison operation may be performed to determine similarity, for example, but comparing a normalized time series of accelerometer vector magnitude samples. The authentication server 110 compares the accelerometer signals (or any other technically feasible vibration signals) sampled by both authentication devices to determine whether both computing devices observed a similar impact waveform. When the accelerometer signals have sufficient similarity and time correlation, the authentication server 110 determines the impact event occurred between both authentication devices. In other embodiments, one or both of the computing devices may compare the accelerometer signals (e.g., by transmitting accelerometer signal data or waveforms).

In some embodiments, the authentication server 110 measures proximity using a combination of two or more proximity signals either separately or in combination. For example, a Bluetooth channel may be established between two computing devices (e.g., authentication device 140 and authentication device 150) and timing information for presenting a 2D optical image may be transmitted over the Bluetooth channel. In such an implementation, the authentication server 110 measures proximity based on the Bluetooth channel and further by transmitting 2D optical images timed according to the timing information transmitted over the Bluetooth channel. In another example, the two computing devices are configured to sample and characterize a local RF environment (an indirect or passive proximity signal) prior to transmitting an explicit optical, acoustic, or mechanical proximity signal. A substantially identical local RF environment indicates device proximity and the authentication server 110 further proves proximity with an explicit proximity signal derived from analysis of the local RF environment. Examples of explicit proximity signals include, but are not limited to, Bluetooth signals, optical signals, and acoustic signals. Further combinations are also possible; for example, the authentication server 110 may sample and characterize both local RF environment and ambient acoustic environments prior to one or more proximity signals being transmitted between authentication devices.

In certain embodiments, the authentication server 110 implements geo-location sensing (e.g., global positioning system or GPS). The authentication server 110 receives a location signal generated for each of two computing devices (e.g., authentication device 140 and authentication device 150) and determines a location difference signal between location signals for the two computing devices. The determined location difference signal represents a proximity signal, which the authentication server 110 may use independently or in combination with one or more other proximity signals. In another embodiment, one or both of the computing devices determine the location difference signal and transmit the location difference signal to the authentication server 110.

More information regarding proximity measurement between two computing devices is described in in U.S. patent application Ser. No. 17/962,494, filed Oct. 8, 2022, which is incorporated by reference herein in its entirety.

### Managing Trust Relationships

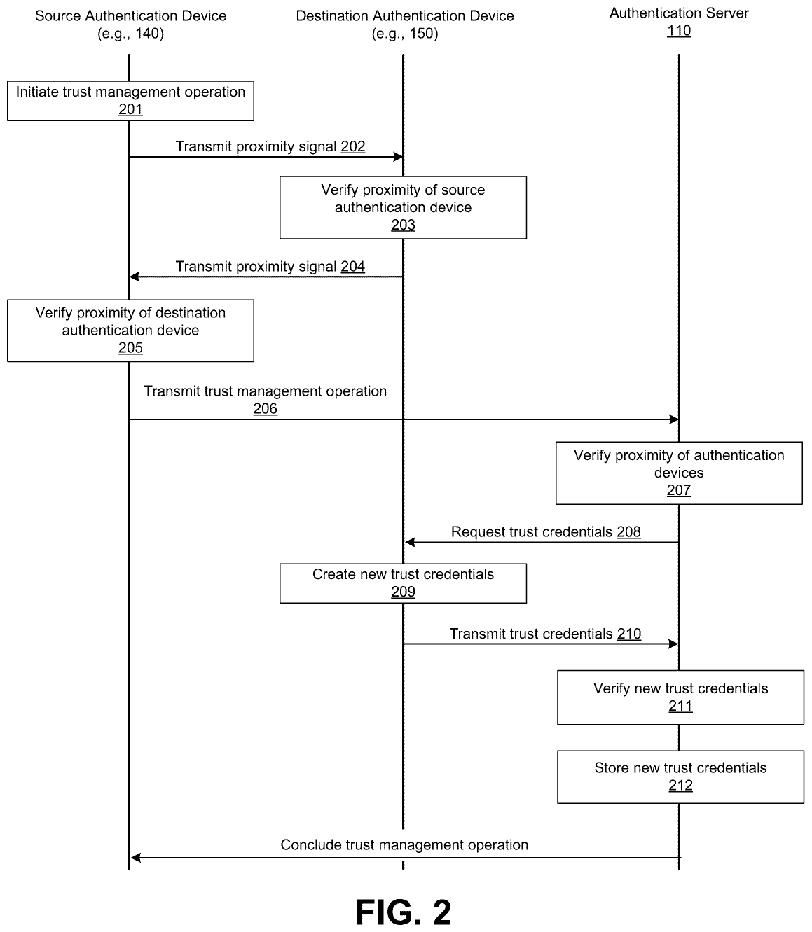

FIG. 2 illustrates and example process 200 for creating a new trust relationship between an authentication server and a destination authentication device, according to one embodiment. In the illustrated embodiment, a source authentication device (e.g., authentication device 140) initiates a trust management operation to transfer trust to a destination authentication device (e.g., authentication device 150). As described herein, a source authentication device is an authentication computing device accessing the application server 118.

The source authentication device initiates 201 a trust management operation by first verifying proximity to the destination authentication device. As described herein, a destination authentication device is an authentication computing device in a trust relationship with the authentication server 110 (e.g., a trusted authentication device). The source authentication device transmits 202 a proximity signal to the destination authentication device. The destination authentication device receives the transmitted proximity signal and verifies 203 that the source authentication device is in proximity to the destination authentication device based on the transmitted proximity signal the proximity measurement techniques described above. In one embodiment, the destination authentication device may compare the proximity signal to a threshold before verifying the proximity of the source authentication device. In other embodiments involving short range signals, detection of a proximity signal alone is sufficient for verifying that the source authentication device is in proximity to the destination authentication device. In other embodiments involving optical signals, the destination authentication device may analyze the size of the image captured by the digital camera and transmitted by the device. The destination authentication device transmits 204 a proximity signal to the source authentication device. The source authentication device receives the transmitted proximity signal and verifies 205 that the destination authentication device is in proximity to the source authentication computing device based on the transmitted proximity signal the proximity measurement techniques described above. In the illustrated embodiment, both the source authentication device and the destination authentication device separately and independently verify the proximity of the two devices based on different proximity signals. In other embodiments, only one of devices may verify the proximity signal and the process described herein may proceed in the same manner otherwise described herein.

Upon verifying that the source authentication device and the destination authentication device are in proximity to each other, the source authentication device transmits 206 the trust management operation (initiated at step 201) to the authentication server 110. The authentication server 110 verifies 207 that the destination authentication device and the source authentication device are in proximity to each other using the proximity measurement techniques described above. FIG. 2 illustrates an embodiment of the process 200 in which the destination authentication device, the source authentication device, and the authentication server 110 each verify that the two authentication devices are in proximity to each other. However, a person of ordinary skill in the art would appreciate that this embodiment is illustrative. In other embodiments of the process 200 (not shown), only one of the source authentication device, the destination authentication device, and the authentication server 110 verifies that the two authentication devices are in proximity to each other. In such embodiments, the proximity of the two authentication devices is verified once by any of three components before the authentication server requests trust credentials from the destination authentication device. In another embodiment, the authentication server 110 may confirm the proximity of the two devices by analyzing unique location-specific data (e.g., audio environment, radio frequency environment, etc.) from both devices, for example using any of the techniques described above. In such embodiments, the authentication server 110 may further transmit a proximity assessment to the source authentication device and/or destination authentication device based on the analysis of the location-specific data.

Upon verifying that the source authentication device and the destination authentication device are in proximity to each other, the source authentication device requests 208 trust credentials from the destination authentication device. The destination authentication device creates 209 trust credentials for a trust relationship between the authentication server 110 and the destination authentication device and transmits 210 the trust credentials to the authentication server. As an example, the destination authentication device may generate a private-public key pair for the trust relationship, store the private key at the device and transmit the public key to the authentication server to be stored in the credentials database. The authentication server 110 may verify 211 the new trust relationship with the destination authentication device. Verification of the new trust relationship is further described below. The authentication server 110 stores 212 the new trust relationship credentials, for example stored in the credentials database described herein.

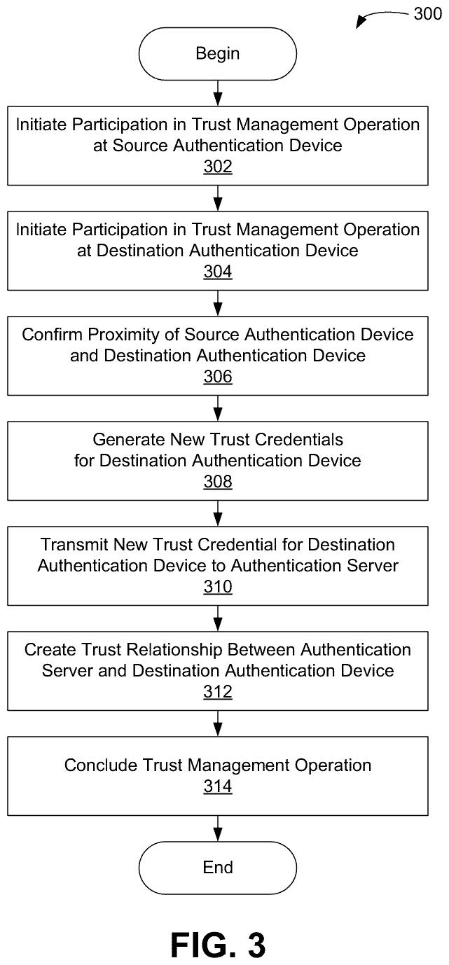

FIG. 3 illustrates an example process 300 for executing a trust management operation to create a trust relationship between an authentication server and a destination authentication device, according to one embodiment. The trust management operation may involve creating a new trust relationship between the destination authentication device and the authentication server. The trust management operation may further involve invalidating an existing trust relationship with the source authentication device upon establishing the new trust relationship, for example in a scenario where an operational or security policy limits the number of trusted authentication devices for a given account and creating a new trust relationship would exceed said limit. A person of ordinary skill in the art would recognize that certain variations on the processes illustrated in FIGS. 3-6, such as reordering of process steps, may be performed for performing the trust management operation without departing the scope of different potential embodiments of the present disclosure. For example, specific ordering of steps within a given process may be modified according to specific implementation requirements.

Returning to FIG. 3, the process 300 begins when the source authentication device initiates 302 a trust management operation, initiating execution of related operations at the source authentication device. To initiate the trust management operation, the source authentication device transmits a message to the authentication server requesting execution of the trust management operation. In some embodiments, upon receipt of the transmitted message from the source authentication device, the authentication server 110 transmits a notification to the destination authentication device to initiate a trust management operation. In other embodiments, the source authentication device (e.g., authentication device 140) transmits the notification to the destination authentication device (e.g., authentication device 150) to initiate a trust management operation. In other embodiments, the authentication server 110 and the source authentication device each transmit separate notifications to the destination authentication device to initiate a trust management operation.

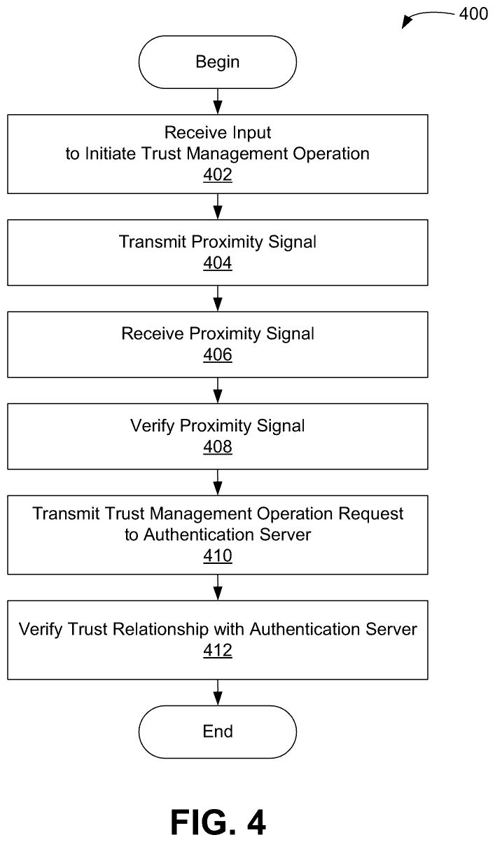

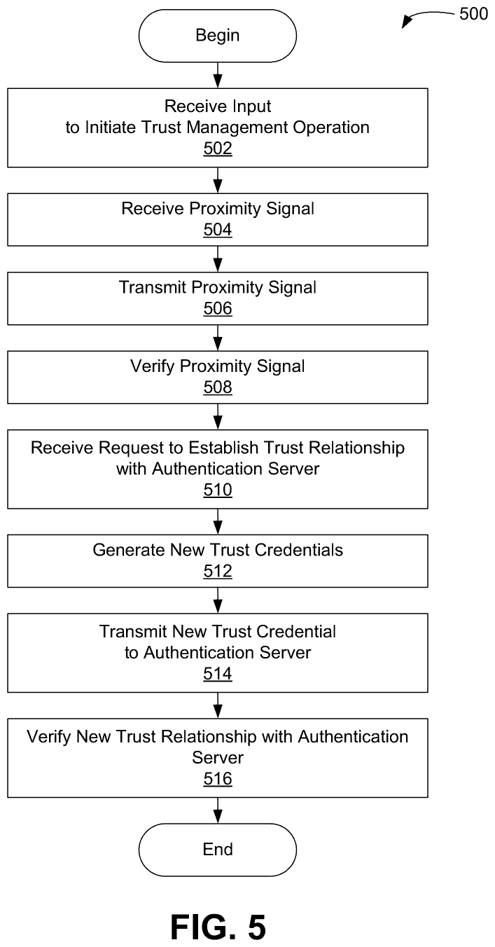

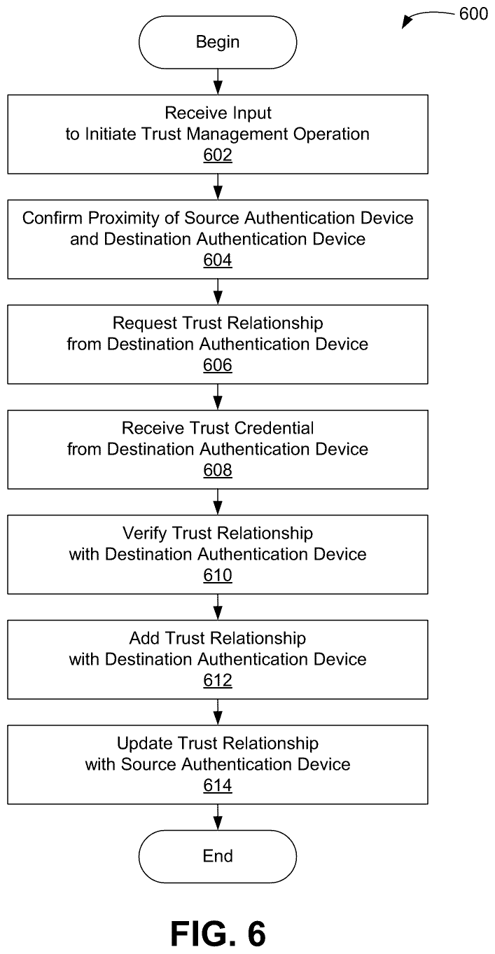

Upon receipt of the notification from one or both of the source authentication device or the authentication server, the destination authentication device initiates 304 the trust management operation initiating related operations at the destination authentication device. At this point, all of the source authentication device, the destination authentication device, and the authentication server 110 are involved in trust management operation, each performing a respective process to complete the trust management operation. FIGS. 4-6 illustrate sub-processes involved in executing a trust management operation. To execute the trust management operation, a source authentication device performs the process illustrated in FIG. 4, the destination authentication device performs the process illustrated in FIG. 5, and the authentication server 110 performs the process illustrated in FIG. 6.

The source authentication device and the destination authentication device are confirmed to be in proximity of each other, in accordance with to any technically feasible technique. One or more of the source authentication device, the destination authentication device, and the authentication server 110 confirm 306 whether the two devices are in proximity of each other. As described above, either device and/or the application server 118 may apply any of the techniques described above involving a proximity signal to determine the proximity of the two devices, for example, BLUETOOTH, NFC, or WiFi connectivity, accelerometer generated bump signal, image scan (e.g., QR code), or audio (e.g., frequency lock, audio attenuation).

Once the two devices are confirmed to be in the proximity of each other, the destination authentication device generates 308 new trust credentials for a trust relationship between the destination authentication device and the authentication server 110. In one embodiment, the trust credentials comprise a public-private key pair. The key pair may be generated in accordance with understood techniques for generating such key pairs. The destination authentication device transmits 310 the new trust credentials to the authentication server 110. Continuing from the example involving the key pairs, the destination authentication device transmits trust credentials to the authentication server 110 including the public key element of the generated public-private key pair. The destination authentication device may transmit the trust credentials over a secure path, for example via a private channel such as an SSL channel, a TLS channel, or any other type of suitable private channel.

The authentication server 110 creates 312 a trust relationship between the authentication server 110 and the destination authentication device based on the generated trust credentials. In an embodiment, the authentication server 110 adds the created trust credential the credentials 112 of FIG. 1. For example, the public key element of the public-private key may be added as a key 114 within a database comprising the credentials 112 (e.g., credentials database). The authentication server 110 may test the trust relationship by transmitting a message, for example through a private or encrypted channel, to the destination authentication device to be signed using the private key stored at the destination authentication device. If the destination authentication device properly signs (i.e., encrypts) the transmitted message with the private key and the authentication server 110 is able to recover the signed message using the corresponding public key (e.g., key 114), the authentication server determines the test to be successful and establishes a trust relationship (or continue to trust) with the destination authentication device.

The authentication server 110 concludes 314 the trust management operation. In one embodiment, the authentication server 110 concludes the trust management operation by increasing the number of trusted authentication devices associated with a user/account to include the destination authentication device. In other embodiments, the authentication server 110 may invalidate (or remove) the trust relationship with the source authentication device, essentially transferring the trust relationship to the destination authentication device from the source authentication device, while preserving the number of trusted authentication devices.

In some embodiments, the authentication server 110 creates new authentication credentials (via the process 200) to provision a new user, new account and new trusted authentication device. In such embodiments, the authentication server 110 may store account details for the new user and associate the appropriate destination (new trusted) authentication device with the new user. The source authentication device may be associated with an account administrator such that the authentication server 110 concludes the trust management operation by associating the new trust relationship with the destination (i.e., new) authentication device and the new account/user. Furthermore, in such embodiments, the trust relationship with the source authentication device is maintained.

FIG. 4 illustrates an example process 400 for a source authentication device (e.g., authentication device 140) to initiate a new trust relationship between an authentication server (e.g., authentication server 110) and a destination authentication device (e.g., authentication device 150), according to one embodiment. In an embodiment, the process 400 may be performed by a computing device configured to serve as the source authentication device, for example a smartphone or smartwatch. In alternate embodiments, the process 400 may be performed by any other feasible computing devices (e.g., a laptop, a tablet computer, etc.). The source authentication device may include a trust management application (not shown) comprising programming instructions that cause one or more processors within the source authentication device to perform the process 400. The programming instructions may be stored in one or more non-transitory computer readable storage mediums, such as a flash memory circuit, a DRAM circuit, and so forth.

The source authentication device receives 402 an input to initiate a trust management operation, for example the input may be to a user interface (UI), an inbound data network message, or any other technically feasible element. The source authentication device transmits 404 one or more proximity signals (e.g., an optical signal, an electromagnetic (RF) signal, an acoustic signal, or a mechanical signal). The source authentication device receives 406 one or more proximity signals from the destination authentication device and verifies 408 the proximity signals. In one embodiment, the source authentication device verifies the proximity signals by confirming that the proximity signal is genuine and originates from a destination authentication device in proximity to the source authentication device. The source authentication device may use any technically feasible technique to verify the proximity signal. In some embodiments, the source authentication device transmits and receives multiple proximity signal messages from and to the proximate destination authentication device and verifies each of the multiple proximity signals. If the source authentication device fails to verify the proximity signal, the authentication server 110 terminates the process 400 because the source and destination devices are not in proximity to each other. In an alternative embodiment, the source authentication device may receive 406 a proximity signal from the destination authentication device (or any other suitable source) without transmitting 404 its own proximity signal. In such embodiments, the received proximity signal may be a short-range radio signal or an optical signal such as a QR code, and/or a signal unique to the environment in which the devices are operating (e.g., an electromagnetic signature unique to the environment). In another alternative embodiment, the source authentication device transmits 404 a proximity signal without receiving 406 a proximity signal from the destination authentication device.

After verifying the proximity signal, the source authentication device transmits 410 a trust a management operation request to the authentication server 110. In one embodiment, the trust management operation request includes a request to add the destination authentication device as a trusted authentication device for an existing account or user associated with the source authentication device. In another embodiment, the trust management operation request includes a request to provision the destination authentication device as a trusted authentication device for a new account or user. In another embodiment, the trust management operation request includes a request to move an existing trust relationship from the source authentication device to the destination authentication device and invalidate the trust relationship with the source authentication device. In alternative embodiments, such as those defined by the authentication server 110 performing proximity authentication, the authentication server 110 may verify the trust relationship with the source authentication device to confirm that the authentication server 110 should proceed with the trust management operation.

The authentication server 110 verifies 410 the trust relationship (e.g., tests the trust relationship). For example, the authentication server 110 may transmit a message to be signed by the source authentication device with the private key. The source authentication device signs the message (e.g., by encrypting it with the private key of a key pair) and transmits the signed message back to the authentication server 110. The source authentication device and the authentication server 110 may transmit and receive the message via a private/encrypted channel. In alternative embodiments, the source authentication device may perform additional process steps to verify the trust relationship between the authentication server 110 and the source authentication device. In one embodiment, various steps of the process 400 are performed during steps 302 and 306 of FIG. 3.

In embodiments where the authentication server 110 transfers a trust relationship from a source authentication device, the source authentication device may confirm whether the transfer has been completed. In one embodiment, the source authentication device may require confirmation of the transfer of the trust relationship prior to the transfer being completed. For example, the source authentication device may generate a UI element displaying a confirmation request for the user to confirm the transfer of the trust relationship. In an embodiment, the confirmation is performed as part of step 412 and/or step 402. In other embodiments, the confirmation request is performed as part of the verification step or prior to transmission of the management operation request.

FIG. 5 illustrates an example process 500 for a destination authentication device (e.g., authentication device 150) to establish a new trust relationship with an authentication server (e.g., authentication server 110), according to one embodiment. In an embodiment, the process 500 may be performed by a computing device configured to serve as the destination authentication device, for example a smartphone or smartwatch. In alternate embodiments, the process 500 may be performed by any other feasible computing devices (e.g., a laptop, a tablet computer, etc.). The destination authentication device may include a trust management application (not shown) comprising programming instructions that cause one or more processors within the destination authentication device to perform the process 500. The programming instructions may be stored in one or more non-transitory computer readable storage mediums, such as a flash memory circuit, a DRAM circuit, and so forth.

The destination authentication device receives 502 an input to initiate a trust management operation, for example input to a user interface (UI) (e.g., a confirmation that a transfer of a trust relationship should be performed), a data network message, or any other technically feasible element. The destination authentication device receives 504 one or more proximity signals from the source authentication device and transmits 506 one or more proximity signals (e.g., an optical signal, an electromagnetic (RF) signal, an acoustic signal, or a mechanical signal). The destination authentication device verifies 508 the proximity signal(s) from the source authentication device, for example using the techniques described above with reference to steps 404, 406, and 408 of FIG. 4. If the destination authentication device fails to verify the proximity signal(s), the authentication server 110 terminates the process 500 because the source and destination devices are not in verifiable proximity to each other.

Once verified, the destination authentication device receives 510 a request to establish a trust relationship with the authentication server 110. In one embodiment, the destination authentication device responds to the request by generating 512 new trust credentials. In one embodiment, the new trust credentials include a public key and a private key of a public-private key pair. The destination authentication device transmits 514 the new trust credentials to the authentication server 110 by sharing a public key of the generated key pair with the authentication server 110.

As described above, the authentication server 110 may verify the new trust credentials by transmitting a message to the destination authentication device to be signed with the new trust credentials (i.e., the newly generated private key). The destination authentication device signs the message by encrypting the message with the private key of the new trust credentials and transmitting the signed message back to the authentication server for verification. Once verified, the authentication server stores the public key of the generated key pair in a database (e.g., a credentials database) that associates the destination authentication device with the public key portion of the new trust credentials. Accordingly, the destination authentication device verifies 516 the new trust relationship by receiving a message from the authentication server 110, encrypting the message with the private key, and transmitting the encrypted message back to the authentication server 110.

The embodiments described herein with respect to operations of a source authentication device (e.g., method 400) and operations of a destination authentication device (e.g., method 500) are intended to be illustrative and not limiting. Furthermore, persons of ordinary skill in the art, in light of the teachings disclosed herein, will understand that various alternative techniques may be performed to prove proximity between a source authentication device and a destination authentication device without departing the scope and spirit of various embodiments.

As described herein, FIGS. 4-5 implement a “handshake” mechanism to generate proximity information at the source authentication device and the destination authentication device, before verifying that the two devices are in proximity to each other based on information obtained during the handshake. In other embodiments (not shown), the source authentication device and the destination authentication device passively receive environmental signals and generate locally unique signal signatures that may provide proof of proximity. In such embodiments, the source authentication device and the destination authentication device may each transmit (e.g., via a wireless Internet connection) their respective local signal signatures to the authentication server 110. The authentication server 110 then compares the two signal signatures and verifies the proximate signals. Upon verifying the signals, the authentication server 110 transmits proof of proximity received to the authentication devices in the form of independent data messages (e.g., via a wireless Internet connection over network 130).

In other embodiments, a QR code is generated (e.g., using a random/pseudorandom number generator) on a display screen of either the source authentication device or the destination authentication device, and the other device (not displaying the QR code) reads the QR code using a digital camera of the other device. In some embodiments, the source authentication device and the destination authentication device each independently transmit a QR code signature (e.g., the literal content of the QR code or a hash thereof) to the authentication server 110 and the authentication server 110 provides proof of proximity to both the source authentication device and the destination authentication device in the form of independent data messages. In such embodiments, either the source authentication device or the destination authentication device may generate and display the QR code and the other device may read the code. Both devices separately transmit QR code data (or hash of the data) from the same QR code to the authentication server 110 and the authentication server 110 compares the transmitted QR code data. If the QR code data received from the source authentication device and the destination authentication device are the same, the authentication server 110 verifies the proximity of the two devices and sends messages to both devices indicating the proof of proximity. If the QR code data from the two devices is not the same, the authentication device determines that the proximity of the two devices cannot be verified.

FIG. 6 illustrates an example process 600 for an authentication server (e.g., authentication server 110) to establish a new trust relationship with a destination authentication device (e.g., authentication device 150), according to one embodiment. While the process 600 may be performed by authentication server 110 of FIG. 1, persons of ordinary skill in the art will recognize that process 600 may be performed by any other suitable computing device with an appropriate data network connection, e.g., over network 130.

The authentication server 110 receives 602 input to initiate a trust management operation, for example a data network message transmitted from the source authentication device through the data network 130 and received by the authentication server 110. The authentication server 110 confirms 604 the proximity between the source authentication device and the destination authentication device. In one embodiment, the source authentication device and the destination authentication device mutually confirm proximity through one or more proximity signals and transmit confirmation to the authentication server 110. In another embodiment, the source authentication device and the destination authentication device transmit and receive proximity signals to each other, and individually transmit received proximity signal data to the authentication server 110 for confirmation. The authentication server 110 compares the signals received from each device and confirms the proximity of the source based on the comparison. In other embodiments, the source authentication device and the destination authentication device provide a local proximity confirmation by communicating proximity signals to each other and the authentication server provides a server proximity confirmation based on the proximity signal data received from the two devices.

Upon confirming the proximity of the two devices, the authentication server 110 requests 606 a trust relationship with the destination authentication device. In one embodiment, the request causes the destination authentication device to generate a new set of trust credentials and transmit a portion of the trust credentials to the authentication server 110. For example, the trust credentials may comprise a public-private key pair and the public key is transmitted to the authentication server 110. The authentication server 110 receives 608 a trust credential (e.g. a public key) from the destination authentication device. The authentication server verifies 610 the new trust relationship with the destination authentication device. In one embodiment, the authentication server transmits a message to the destination authentication device and receives from the destination authentication device an encrypted (using the private key of the public-private key pair) version of the transmitted message. The authentication server 110 verifies the trust relationship by decrypting the signed message using the corresponding public key of the public-private key pair and comparing the original message to the decrypted version of the signed message.

If the authentication server fails to verify the new trust relationship, the authentication server 110 terminates the process 600 (not shown). In such circumstances, the authentication server 110 may generate and store an error message in a log file, transmit the error message to an administrator, or both.

If the authentication server does verify the new trust relationship, the authentication server 110 adds 612 the new trust relationship to a database of existing trust relationships maintained by the authentication server 110. The authentication server 110 updates 614 the trust relationship with the source authentication device 140. In certain embodiments, the authentication server 110 updates the trust relationship with the source authentication device 140 by invalidating another trust relationship with the source authentication device 140. In other embodiments, a new user or account may be added to the database of current trust relationships and the authentication server 110 may associate the new trust relationship with the new account. In such embodiments, the source authentication device may be an administrative device operated by the account administrator. Once a trust relationship is established between the authentication server 110 and the destination authentication device, a computer device (e.g., computer device 160) may gain access to networked applications or cloud-based applications (e.g., applications 119) executing within and an application server (e.g., application server 118) by using the destination authentication device to authenticate access. In an embodiment, the destination authentication device must be verifiably within proximity of the computer device for the computer device to gain such access.

### Computing Machine Architecture

FIG. 7 is a block diagram illustrating components of an example machine able to read instructions from a machine-readable medium and execute them in a processor (or controller). Specifically, FIG. 7 shows a diagrammatic representation of a machine in the example form of a computer system 700 within which instructions 724 (e.g., software) for causing the machine to perform any one or more of the processes or (methodologies) discussed herein (e.g., with respect to FIGS. 1-6) may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment. It is noted that some or all of the components described may be used in a machine to execute instructions, for example, those corresponding to the processes described with the disclosed configurations.

The machine may be a server computer, a client computer, a personal computer (PC), a tablet PC, a set-top box (STB), a personal digital assistant (PDA), a cellular telephone, a smartphone, a web appliance, an IoT device, a wearable, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes a processor 702 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a static memory 706, which are configured to communicate with each other via a bus 708. The computer system 700 may further include visual display interface 710. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 710 may include or may interface with a touch enabled screen. The computer system 700 may also include alphanumeric input device (e.g., a keyboard or touch screen keyboard), a cursor control device 714 (e.g., a mouse, a trackball, a joystick, a motion sensor, or other pointing instrument), a storage unit 716, a signal generation device 718 (e.g., a speaker), and a network interface device 720, which also are configured to communicate via the bus 708. It is noted that the example computer system 700 need not include all the components but may include a subset.

The storage unit 716 includes a machine-readable medium 722 on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network 726 via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies disclosed herein. The term “machine-readable medium” includes, but not be limited to, data repositories in the form of solid-state memories, optical media, and magnetic media. It is noted that the processor 702 includes one or more processors. Further each of the main memory 704, the static memory 706 and the storage unit 716 and machine readable medium also includes one or more of each, respectively.

### Additional Configuration Considerations

The disclosed computing environment 100 enables enterprise systems to manage trust relationships between an authentication server and authentication devices. Compared to conventional trust provisioning systems, the disclosed techniques provide greater operational efficiency by enabling safe and secure management of credentials among devices without additional cumbersome logistical requirements, such as showing up in person with an authorized representative of a credential service provider (CSP) to transfer a NIST SP 800-63A level IAL3 identity proof from one authentication device to a different authentication device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for systems and a process for confirming an identity based on characteristic data received from various sources through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope of embodiments of the present disclosure.

What is claimed is:

1. A method for transferring a trust relationship between a first device and a second device, the method comprising:
receiving, from a first device, a request to access an authentication server;
receiving, at the authentication server, one or more proximity signals transmitted from the first device and one or more proximity signals transmitted from a second device, wherein the second device has a trust relationship with the authentication server, the trust relationship establishing that the second device can access the authentication server;
confirming that the first device and the second device are in proximity to each other based on the one or more proximity signals transmitted from the first device and the one or more proximity signals transmitted from the second device;
verifying the trust relationship with the second device by decrypting a signed message received from the second device after confirmation that the first device and the second device are in proximity to each other; and
updating a trust relationship between the first device and the authentication server based on the verified trust relationship between the second device and the authentication server after verification of the trust relationship with the second device.

2. The method of claim 1, wherein the one or more proximity signals comprises at least one of:
an optical signal;
an electromagnetic signal;
a magnetic signal;
an acoustic signal; and
a mechanical signal.

3. The method of claim 1, wherein the trust relationship between the first device and the authentication server is defined by a private-public key pair, the first device storing a private key of the private-public key pair and the authentication server storing a public key of the private-public key pair.

4. The method of claim 1, wherein confirming that the first device and second device are in proximity to each other comprises:
comparing the one or more signals received from the first device and the one or more signals received from the second device.

5. The method of claim 1, wherein confirming that the first device and second device are in proximity to each other comprises:
receiving first QR code data from the first device, wherein the first device displays a QR code;
receiving second QR code data from the second device, wherein the second device reads the displayed QR code using a digital camera of the second device; and
comparing the first QR code to the second QR code to confirm that the first device and second device are in proximity to each other.

6. The method of claim 1, wherein verifying the trust relationship with the second device comprises:
transmitting a message to the second device;
receiving, from the second device, an encrypted version of the transmitted message, wherein the transmitted message is encrypted using a private key of a private-public key pair stored at the second device; and
decrypting the encrypted version of the transmitted message, wherein the transmitted message is decrypted using a public key of a private-public key pair stored at the authentication server.

7. The method of claim 1, wherein the authentication server is unable to verify the trust relationship with the second device, the method further comprising:
generating an error message in a log file; and
transmitting the error message to an administrator.

8. The method of claim 1, wherein updating the trust relationship between the first device and the authentication server comprises:
receiving a second public-private key pair from the second device;
transmitting a private key of the second public-private key pair to the first device; and
storing a public key of the second public-private key pair at the authentication server, the public key representing the updated trust relationship.

9. The method of claim 1, wherein updating the trust relationship between the first device and the authentication server comprises one or more of:
transferring the trust relationship between the second device and the authentication server to the first device and
transferring the trust relationship between the second device and the authentication server to the first device.

10. The method of claim 1, wherein updating a trust relationship between the first device and the authentication server comprises:
invalidating an existing trust relationship assigned to the first device; and
replacing the existing trust relationship with the trust relationship between the second device and the authentication server.

11. A non-transitory computer readable storage medium comprising stored program code, the program code comprised of instructions, the instructions when executed causes a processor system to:
receive, from a first device, a request to access an authentication server;
receive, at the authentication server, one or more proximity signals transmitted from the first device and one or more proximity signals transmitted from a second device, wherein the second device has a trust relationship with the authentication server, the trust relationship establishing that the second device can access the authentication server;
confirm that the first device and the second device are in proximity to each other based on the one or more proximity signals transmitted from the first device and the one or more proximity signals transmitted from the second device;
verify the trust relationship with the second device by decrypting a signed message received from the second device after confirmation that the first device and the second device are in proximity to each other; and
update a trust relationship between the first device and the authentication server based on the verified trust relationship between the second device and the authentication server after verification of the trust relationship with the second device.

12. The computer readable storage medium of claim 11, wherein the trust relationship between the first device and the authentication server is defined by a private-public key pair, the first device storing a private key of the private-public key pair and the authentication server storing a public key of the private-public key pair.

13. The computer readable storage medium of claim 11, wherein instructions to confirm that the first device and second device are in proximity to each other further comprises instructions to cause the processor system to:
compare the one or more signals received from the first device and the one or more signals received from the second device.

14. The computer readable storage medium of claim 11, wherein instructions to confirm that the first device and second device are in proximity to each other further comprises instructions to cause the processor system to:
receive first QR code data from the first device, wherein the first device displays a QR code;
receive second QR code data from the second device, wherein the second device reads the displayed QR code using a digital camera of the second device; and
compare the first QR code to the second QR code to confirm that the first device and second device are in proximity to each other.

15. The computer readable storage medium of claim 11, wherein instructions to verify the trust relationship with the second device further comprises instructions to cause the processor system to:
transmit a message to the second device;
receive, from the second device, an encrypted version of the transmitted message, wherein the transmitted message is encrypted using a private key of a private-public key pair stored at the second device; and
decrypt the encrypted version of the transmitted message, wherein the transmitted message is decrypted using a public key of a private-public key pair stored at the authentication server.

16. The computer readable storage medium of claim 11, further comprising instructions that, if the authentication server is unable to verify the trust relationship with the second device, cause the processor system to:
generate an error message in a log file; and
transmit the error message to an administrator.

17. The computer readable storage medium of claim 11, wherein instructions to update the trust relationship between the first device and the authentication server further comprises instructions to cause the processor system to:
receive a second public-private key pair from the second device;
transmit a private key of the second public-private key pair to the first device; and
store a public key of the second public-private key pair at the authentication server, the public key representing the updated trust relationship.

18. The computer readable storage medium of claim 11, wherein instructions to update the trust relationship between the first device and the authentication server further comprises instructions to cause the processor system to:
transfer the trust relationship between the second device and the authentication server to the first device and
transfer the trust relationship between the second device and the authentication server to the first device.

19. The computer readable storage medium of claim 11, wherein instructions to update the trust relationship between the first device and the authentication server further comprises instructions to cause the processor system to:
invalidate an existing trust relationship assigned to the first device; and
replace the existing trust relationship with the trust relationship between the second device and the authentication server.

20. A system comprising:
a first device configured to request access to an authentication server;
a second device having a trust relationship with the authentication server, the trust relationship establishing that the second device can access the authentication server; and
an authentication server configured to:
receive, from the first device, a request to access an authentication server;
receive one or more proximity signals transmitted from the first device and one or more proximity signals transmitted from a second device;
confirm that the first device and the second device are in proximity to each other based on the one or more proximity signals transmitted from the first device and the one or more proximity signals transmitted from the second device;
verify the trust relationship with the second device by decrypting a signed message received from the second device after confirmation that the first device and the second device are in proximity to each other; and
update a trust relationship between the first device and the authentication server based on the verified trust relationship between the second device and the authentication server after verification of the trust relationship with the second device.
